(19) United States
(12) Patent Application Publication
(10) Pub. No.: US 2012/0317137 A1
(43) Pub. Date: Dec. 13, 2012

(54) METHOD FOR MULTI-DIMENSIONAL DATABASE STORAGE AND INQUIRY

(75) Inventor: Zhonghui Wu, Guangzhou (CN)

(73) Assignee: GUANGZHOU CCM INFORMATION SCIENCE & TECHNOLOGY CO., LTD., Guangzhou, Guangdong (CN)

(21) Appl. No.: 13/575,597

(22) PCT Filed: Jan. 6, 2011
(86) PCT No.: PCT/CN11/00026

§ 371 Date: Jul. 26, 2012

(30) Foreign Application Priority Data
Jan. 28, 2010 (CN) 201010104308.2

(51) Int. Cl. G06F 17/30

(52) U.S. Cl. 707/769; 707/812; 707/E17.014; 707/E17.044

(57) ABSTRACT

A method for data storage is disclosed. The method includes the following steps: establishing an entity table for storing entity information in a database (901); storing the entity information into the entity table (902); establishing a state table for storing state information of the entity in the database (903); storing the state information of the entity into the state table (904); associating the entity table with the state table (905); associating the state tables by using time dimension (906). A data storage structure and a method for storing and inquiring data in the data storage structure are also disclosed.

### FIELD OF THE INVENTION

The present invention relates to database technology, and in particular to a method for multi-dimensional database storage and inquiry.

### BACKGROUND OF THE INVENTION

Different information is recorded to the database as the method of event process in traditional two-dimensional database technology, and the storage method is somebody doing something at sometime, and associating those information record table through a certain key column, such as somebody, something etc. If meet some multi-dimensional data, it will be appeared more shortcomings under this kind of management, for example, the oversized data and table, difficult achieved relationship between dimensions of data and against the secondary data mining etc.

For some multi-dimensional information, such as marketing research, state trends, and the information includes types of dimensional individuals, various kinds of properties and features for every individual, individual event, time and location etc. Under this complex multi-dimensional information storage, the management method of the traditional two-dimensional database is as follows:

Firstly, as shown in Table. 1, type of individuals in a table is set up in the traditional one-dimensional database, then storing all categorized individuals to this table. For example, categorizing as the micro-individuals (such as product) and macro-individuals (such as company), and separating the kinds of micro-individuals and macro-individuals.

TABLE 1
Types of individuals

| Types of individuals | Itemized types of individuals |
|---|---|
| Micro-individuals | Micro-individual A |
| | Micro-individual B |
| | . . . |
| Macro-individuals | Macro-individual A1 |
| | Macro-individual B1 |
| | . . . |

Secondly, after establishing the type of individuals table, as shown in Table. 2, the traditional two-dimensional database will establish a micro-individual information property table for every kind of individual, add property of the associating micro-individual to this table, and make some important properties which can divide different micro-individuals to the unrepeatable term. Then, the micro-individual as a main associating term is associated to the micro-individual event table (Table. 3).

TABLE 2
Properties of micro-individuals

| Micro-individuals | | | | | | |
|---|---|---|---|---|---|---|
| (such as product) | Property 1 | Property 2 | Property 3 | Property 4 | . . . | Property N |
| Individual A | Feature 1 | Feature 2 | Feature 3 | Feature 4 | . . . | Feature N |
| Individual B | Feature 1′ | Feature 2′ | Feature 3′ | Feature 4′ | . . . | Feature N′ |
| Individual C | Feature 1″ | Feature 2″ | Feature 3″ | Feature 4″ | . . . | Feature N″ |
| . . . | . . . | . . . | . . . | . . . | . . . | |

TABLE 3
Micro-individuals item table

| | Happening | Event | Event | Happening | Happening | | |
|---|---|---|---|---|---|---|---|
| Micro-individuals | event | object 1 | object 2 | time | location | Situations | Comments |
| Individual A | Event 1 | Individual E | Individual G | **** ** | XXX | XXX | XXX |
| | | | | ** | | | XXX |
| Individual B | Event 1 | Individual A | Individual K | **** ** | XXX | XXX | XXX |
| | | | | ** | | | XXX |
| Individual C | Event 2 | China | United | **** ** | XXX | XXX | XXX |
| | | | States | ** | | | XXX |
| . . . | . . . | . . . | . . . | . . . | . . . | . . . | . . . |

Thirdly, similarly, as shown in Table. 4, the basic macro-individual information primary table of industry is built in the database, when the traditional database macro-individual is recording the macro-individual multi-dimensional information, and storing the associating property to this table. Table. 4 is associated to Table. 5 through macro-individual and Table. 4 is associated to Table. 5 through the element.

TABLE 4
Properties table of macro-individuals

| Macro-individuals | | | | | | |
|---|---|---|---|---|---|---|
| (such as company) | Property 1 | Property 2 | Property 3 | Property 4 | . . . | Property N |
| Individual A | Feature 1 | Feature 2 | Feature 3 | Feature 4 | . . . | Feature N |
| Individual B | Feature 1′ | Feature 2′ | Feature 3′ | Feature 4′ | . . . | Feature N′ |
| Individual C | Feature 1″ | Feature 2″ | Feature 3″ | Feature 4″ | . . . | Feature N″ |
| . . . | . . . | . . . | . . . | . . . | . . . | |

TABLE 5
Properties table of macro-individuals element

| Macro-individuals | Subdivided element | Element | Element | Element | Element | | Element |
|---|---|---|---|---|---|---|---|
| (such as company) | (such as employee) | property 1 | property 2 | property 3 | property 4 | . . . | property N |
| Individual A1 | Element 1 | Feature 1 | Feature 2 | Feature 3 | Feature 4 | . . . | Feature N |
| Individual B1 | Element 2 | Feature 1′ | Feature 2′ | Feature 3′ | Feature 4′ | . . . | Feature N′ |
| Individual C1 | Element 3 | Feature 1″ | Feature 2″ | Feature 3″ | Feature 4″ | . . . | Feature N″ |
| . . . | . . . | . . . | . . . | . . . | . . . | . . . | |

Thereof, subdivided element is belonged to a component of macro-individual, such as the staff in the company, if the company element also can be subdivided and set up the subdivided table.

TABLE 6
State table of macro-individuals

| Elements of | | | | | | |
|---|---|---|---|---|---|---|
| micro-individual | Happening | | | Happening | | |
| entity A | event | Event object 1 | Event object 2 | time | Situations | Comments |
| Element 1 | Event 1 | Individual C | Individual D | **** ** ** | XXX | XXX |
| Element 1 | Event 2 | Individual F | Individual C | **** ** ** | . . . | . . . |
| Element 2 | Event 1 | Individual B | Individual K | **** ** ** | XXX | XXX |
| Element 2 | Event 2 | Individual C | Individual E | **** ** ** | . . . | |
| . . . | . . . | . . . | . . . | . . . | . . . | . . . |

It follows that the associating method of the traditional two-dimensional database as shown in FIG. 1. In FIG. 1, dimension X means property dimension of hierarchy as individual associating, wherein the types of individuals table is associated to the property table of each individual, and each property table is associated to the corresponded individual event table; dimension Y means paratactic individual dimension which divided through the types of individuals, such as individual A, B and C etc.

This kind of traditional two-dimensional database is also existed the following shortcomings when storing and searching multi-dimensional data information.

Firstly, though the traditional two-dimensional database can guarantee the independence and small repeatability of the individual information, in a individual table, the number of individual happened events will be a lot in a certain time period, which the set of event table will be very complex, for example, a huge and unforeseeable final quantity of forms will be appeared in the event object, and it cannot set the event table to be recorded all multi-dimensional information of this individual. If every individual is storing such a huge number of information, it will waste a lot storage space, and maintaining operation of add, delete and amend will be complicated,

Secondly, associating as the individual between tables is ordinarily in management method of the traditional two-dimensional database, and the other properties are all belonged to the other one-dimensional listed in table. But if the other dimension such as property of individual, happening event are existed relationship, this kind of traditional one-dimensional database cannot satisfy the data associating between dimensions.

Thirdly, in the traditional two-dimensional database, inquiring multi-dimensional information is also a difficult thing, the structure as shown in FIG. 4; it only can get the results as some individual doing something at sometime or comments. But if there are several events happening at the same time in this individual, and these events are crossed each other (some dimensions have relationship), these information cannot inquire out. Thus, when using the traditional two-dimensional database to store and inquire the multi-dimensional information, the stored data cannot make fully used, and some information can only be used once. The potential value of multi-dimensional data cannot be effectively developed, and also against with the first mining of data.

Fourthly, the recording method of the traditional two-dimensional database also can be caused some recording errors in data tables. Since the traditional two-dimensional database does not standard or identify all the fields in the event and will cause the recording errors, for example, the system recognizes apple, Apple as different product, which actually express the same product with the difference of input error. This kind of recording method will cause a large number of useless contents in the database and a large data redundancy.

In conclusion, modern society is appearing a trend of diversification, which all the data and index are developing along the multi-dimension direction. For example, market information of a product includes several dimensions such as production, consumption, factory, imports and exports, time and location etc. The traditional two-dimensional database is appeared stretched in this complex multi-dimensional information, and cannot store and associate the information completely in the database, which also cannot process the efficient inquiry.

### SUMMARY OF THE INVENTION

An object of the present invention is effectively storing multi-dimensional data to save more storage space, and the embodiments of present invention can solve the above problems.

The technical proposal of the present invention achieves a multi-dimensional data storage method through establishing multi-dimensional cross database and uses the time as axis, which can overcome the traditional database cannot store the multi-dimensional information completely to the database.

The present invention can store the kaleidoscopic multi-dimensional information (such as market information) as optimization way to save the storage source. It also avoids a complex update and maintaining work of the traditional method, when storing the multi-dimensional information, which only at a certain time cross-section and amending the state of associated entity to achieve the update and maintaining of the database. In other words, the database is only needed to be updated and maintained after an event happens in the entity. In addition, the present invention also provides a inquiry method in multi-dimensional database, which inquiring and presenting the multi-dimensional information stored in database as traditional two-dimensional method through the cross comparison of time, state and entity.

### BRIEF DESCRIPTION OF THE DRAWINGS

FIG. 1 is a two-dimensional associated schematic drawing of a traditional two-dimensional database technology;

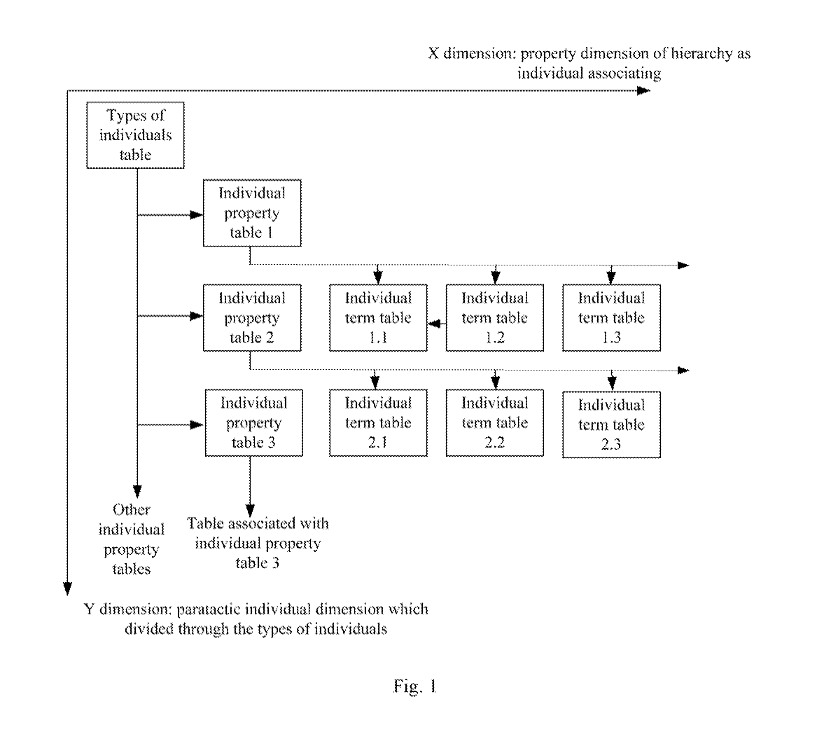

FIG. 2 is a schematic drawing which associated between source database individuals and elements according to an embodiment of the present invention;

FIG. 3 is an associating model among entity tables according to an embodiment of the present invention;

FIG. 4 is an associating model among state tables according to an embodiment of the present invention;

FIG. 5 is a process schematic drawing according to an embodiment of the present invention, which adding an entity, identifying the other associated entities and states and storing to a database;

FIG. 6 is a flow chart according to an embodiment of the present invention, which adding an entity, identifying the other associated entities and states and storing to a database;

FIG. 7 is a specific implement schematic drawing of identification and backward identification according to an embodiment of the present invention;

FIG. 8 is a schematic drawing of specific implement steps of the inquiry database according to an embodiment of the present invention;

FIG. 9 is a schematic drawing of data storage method according to an embodiment of the present invention.

### DETAILED DESCRIPTION OF ILLUSTRATED EMBODIMENTS

The present invention is provided a multi-dimensional data storage and inquiry method which used time axis as the core, which includes the following aspects according to an embodiment of the invention:

1. Identifying

(1) Identifying Method of Data:

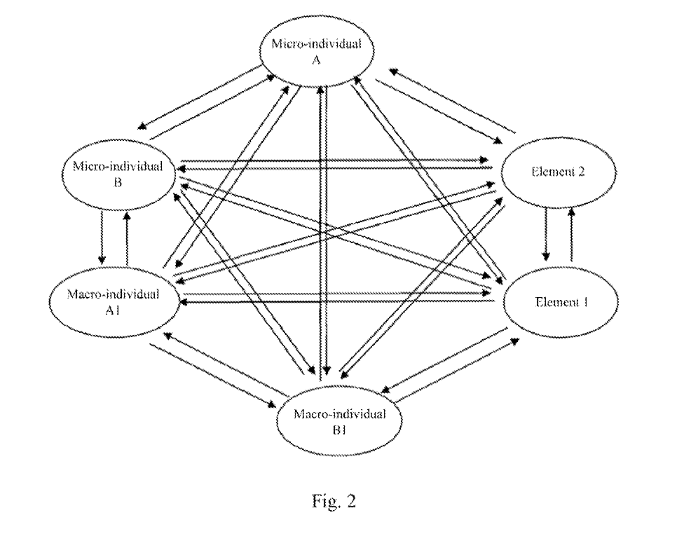

Compared to the simple identifying method of the traditional one-dimensional database, the present invention sets the cross associating data identifying for all data. As shown in FIG. 2, the present invention divides entity to micro-individual, macro-individual and element, and the definitions as following:

Micro-individual: an entity which cannot be subdivided any more, such as a product in the market research industry, people, etc.

Macro-individual: an entity which can be subdivided and also treated as an entirety, such as a country, a juridical person or an industry etc.

Element: The components in macro-individual which is formed this macro-individual, such as a province in a state, a certain product in the industry and someone or a certain machine in the enterprise etc.

The present invention cross associates every entity through the identifying every entity which is associated to the associating entity in every entity table. After an entity is stored or inquired in the database, the database will find the other associated entity through associating identifying, such as name of associating entity or ID. In addition, these cross associating can associate the entity table and state table.

(2) Backward Identifying:

For the convenience of multi-dimensional database management, the present invention also sets a backward identifying. When adding or amending an associating entity (also called receptor in the present invention) of certain entity (also called main body in the present invention) in a certain entity table, and/or the receptor in the state table, which is associated to the state of a certain subject. At the same time, it also request the user processing backward identifying in the entity table and/or state table of entity, and guarantees the symmetry of information in the database.

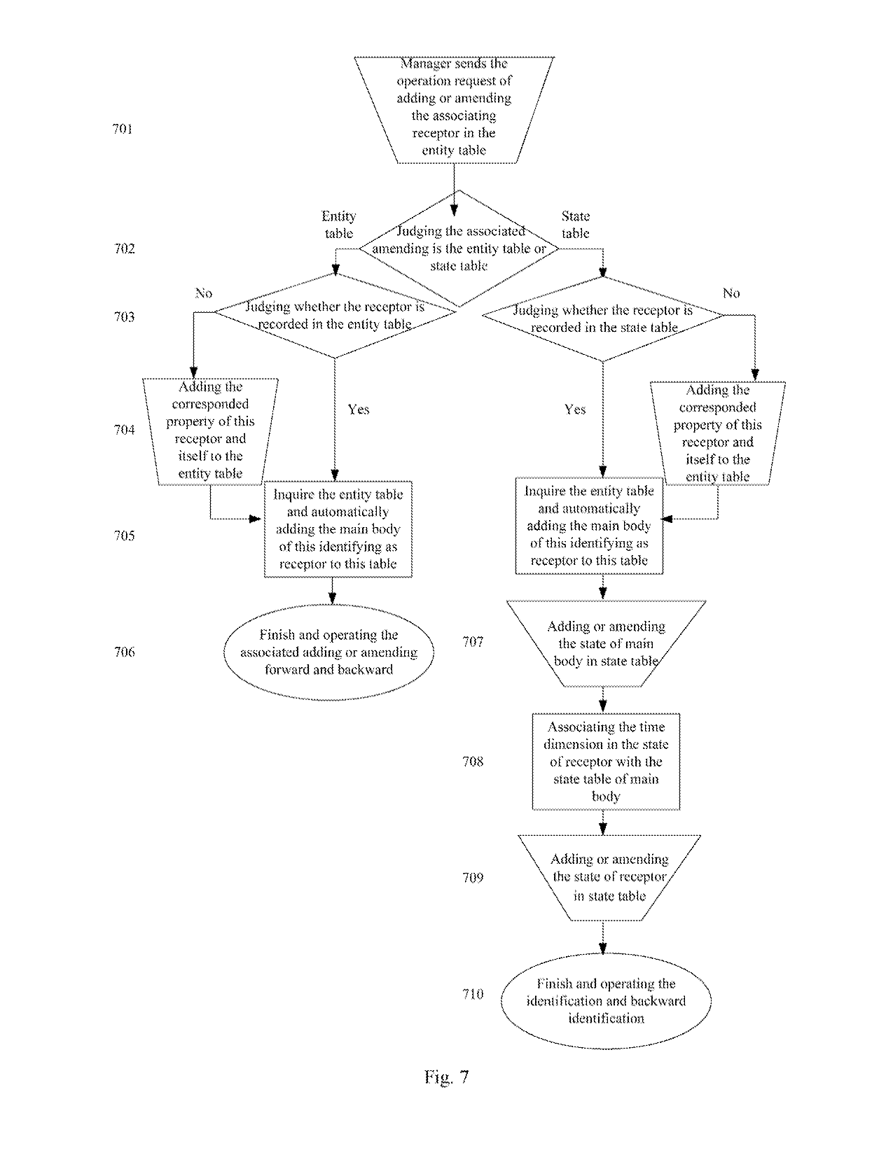

Specific implement process of identification and backward identification in the present invention is referred to FIG. 7.

2. Defining the Entity Table and the Associating Module

The following are combined the Table. 7-9 entity table of the present invention and described more detail. The present invention will be set up the different two-dimensional data table 7-9 and defined as the entity table. The entity corresponded to the entity table can be a macro-individual, micro-macro individual, even an element in macro-individual.

TABLE 7
Micro-individuals entity table

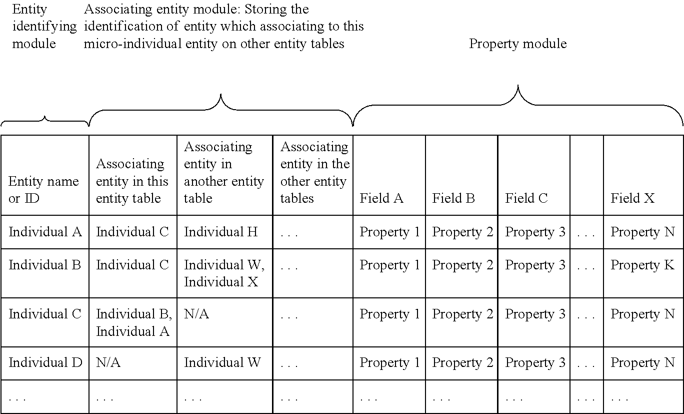

Referring to FIG. 7, the micro-individual table of the present invention includes three modules: entity identifying module, associating entity module and property module. The entity identifying module is used for storing the identification of micro-individual entity, such as name or ID. The associating entity module includes one or more associating term and is used for storing the identification of entity which is associated to the corresponded entity of micro-individual in the other entity tables. The property module is used for storing property which associating to the corresponded entity of micro-individual. As same as two-dimensional database, the micro-individual entity table of present invention is also used to store various basic properties in this entity table, the associating entity in another or the other entity tables, thereby associating this entity table to the other entity tables.

TABLE 8
Macro-individuals entity table

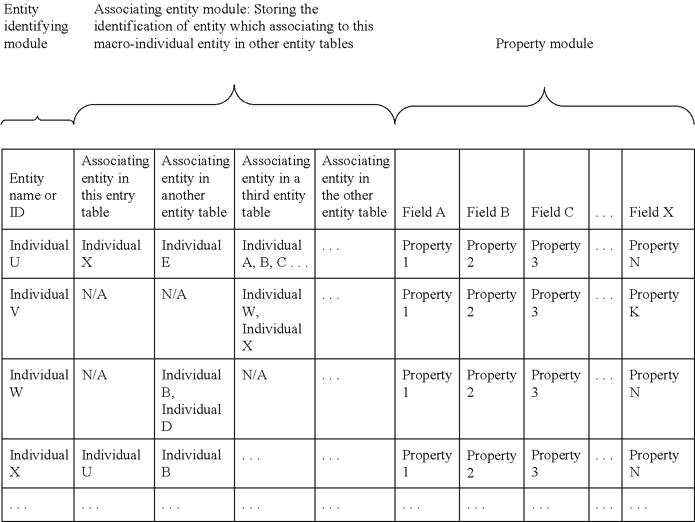

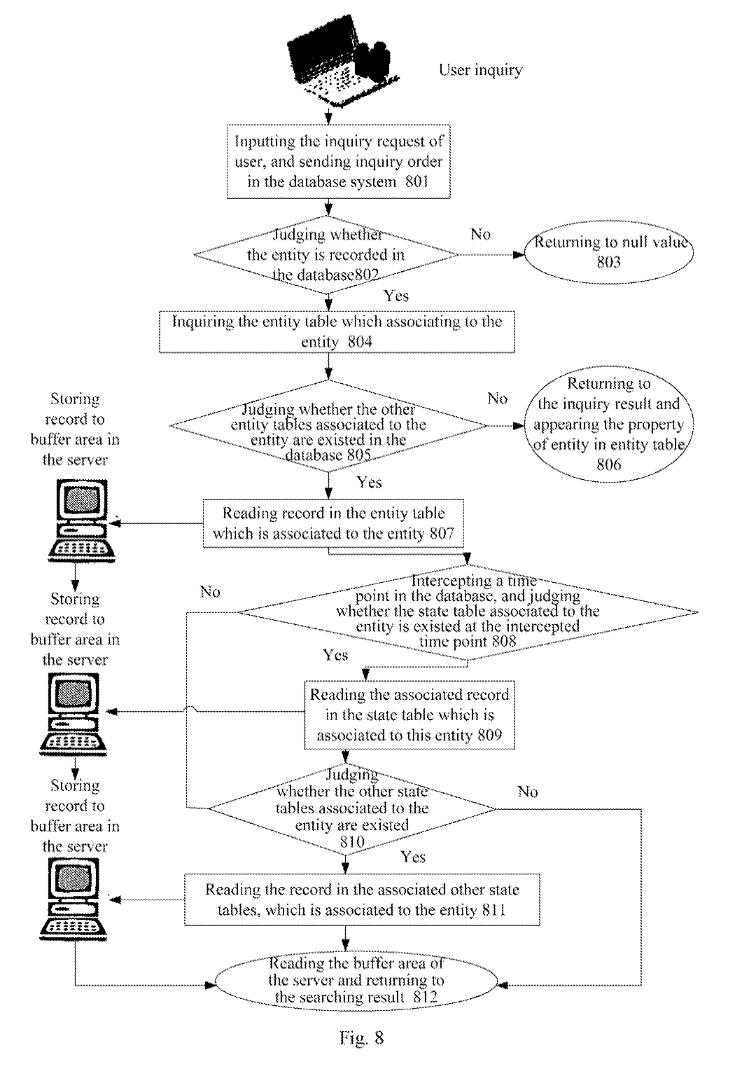

Referring to FIG. 8, which is similar to micro-individual entity table, macro-individual table of the present invention includes three modules: entity identifying module, associating entity module and property module. The entity identifying module is used for storing the identity of macro-individual entity, such as name or ID. The associating entity module includes one or more associating term and is used for storing the identity of entity which associating to the corresponded entity of macro-individual in the other entity tables. The property module is used for storing property which associating to the corresponded entity of macro-individual.

TABLE 9
Entity table of elements

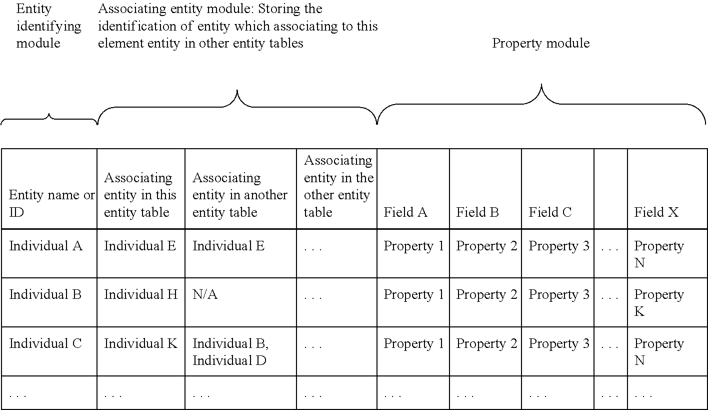

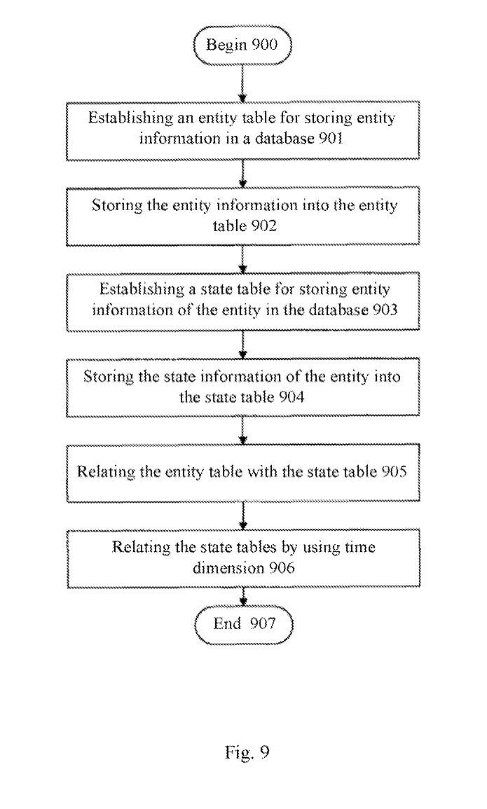

Referring to FIG. 9, which is similar to micro-individual and macro-individual entity table, the element entity table of present invention also includes three modules: entity identifying module, associating entity module and property module. The entity identifying module is used for storing the identity of element entity, such as name or ID. The associating entity module includes one or more associating terms and is used for storing the identity of entity which associating to the corresponded entity of element in the other entity tables. The property module is used for storing property which associating to the corresponded entity of element.

Referring to Table. 7-9, in associating entity module of entity table, it can be set several kinds and quality associating term of entity table according to the different types of this entity, such as micro-individual, macro-individual or element etc. Firstly, setting the associating term of entity in this table and the associating term of entity in other tables which according to the different associating condition between the entities. For two entities which are associated each other, storing associating terms respectively in their own corresponded tables.

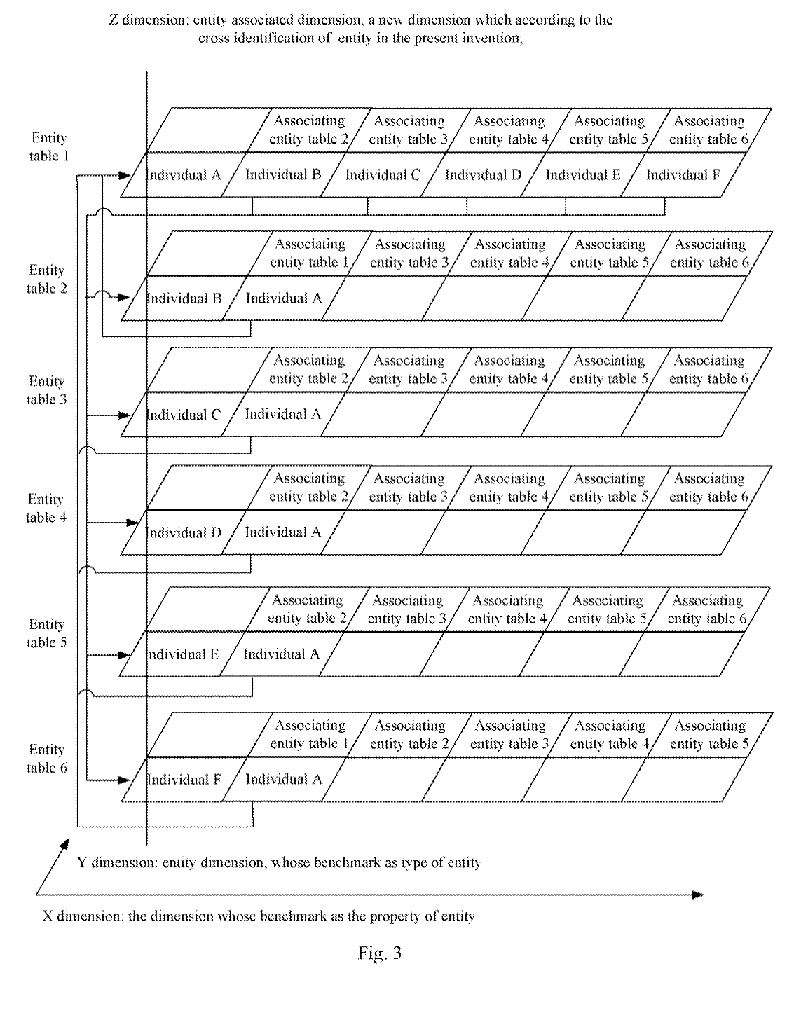

FIG. 3 shows an associating model among entity tables according to an embodiment of the present invention. Referring to FIG. 3, X dimension is the dimension whose benchmark as the property of entity, and Y dimension is the dimension whose benchmark as type of entity. The present invention achieves the association of entity in every entity table through the introduction of the associating entity module, and these entity tables are formed a new dimension (Z dimension) according to these association. The entity associating dimension is a new dimension which according to the cross identification of entity in the present invention, and these entity tables are formed to the three-dimensional entity table-array module in FIG. 3 after associating the associating module which is defined among the entities.

3. Defining State Table and the Associating Module

Except defining the entity table, the present invention also sets a data table which is recorded the state of multi-dimensional information entity; that is a state table. In the state table, setting the time dimension as the basic dimension of state table, and the associated various state of entity can be served as the object of storing.

For example, the macro-individual state table (Table. 10) and the micro-individual state table (Table. 11), including time dimension module is used for storing the happening time of activities as scheduled time granularity (such as year, month, day, hour, minute and second etc), and in order to associate each activity of entity in state table; the main entity identifying module is used for storing the identification of main entity, such as name or ID of main entity; and the associating state module which is set in the state table through data identifying technology is used for storing the associating state of main entity (such as U) in storing state table, including the happening activities between main entity (such as L) and associating entity (such as C, A and Z etc.) and/or the happening activities, changes etc. of entity itself. Thereof, the main entity and associating entity are the relative concept, for the macroscopic angle, it is not necessary to distinguish between primary and secondary of each associating entity which is affected each other. For a certain entity angle, the happening activity between this entity and other entities, this entity can be seen as main entity and the other entities which are happened associating activity with this entity can be seen as associating entity. Since there will appear different state between the main entity and the same associating entity, it is necessary to subdivide the associating state to the different types. For example, if individual U is the macro-individual, a company respectively bought and sold X and Y tons of individual C (a certain product) at January, 2008, and storing respectively as shown in Table. 10 and Table. 11 in the state tables of individual U and individual C. Although the Table 10 and Table 11 only present the state of each associating entity, the person skilled in this area will understand that the main entity not only could happen to the various states with other entities, but also could happen to various changes on it. Thus, the changes of main entity also are belonged to the storing object of associating state module.

TABLE 10
Macro-individual state tables

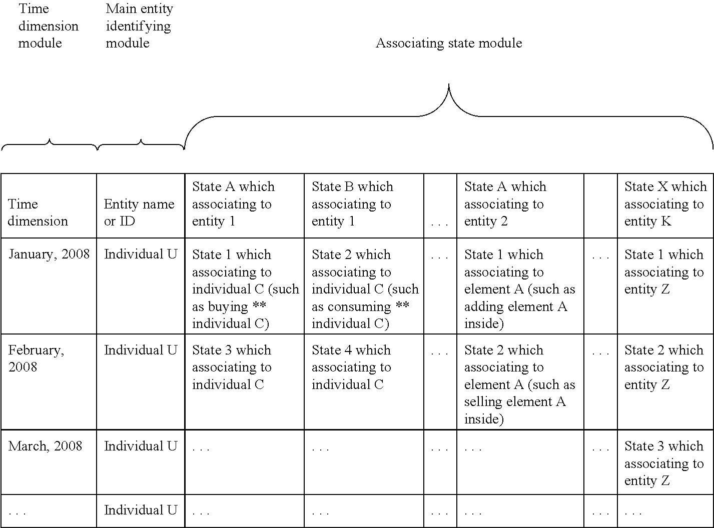

TABLE 11
Macro-individual state tables

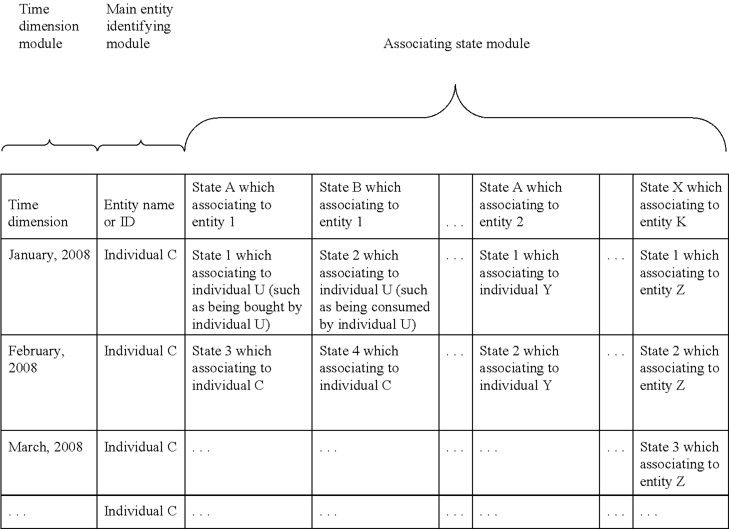

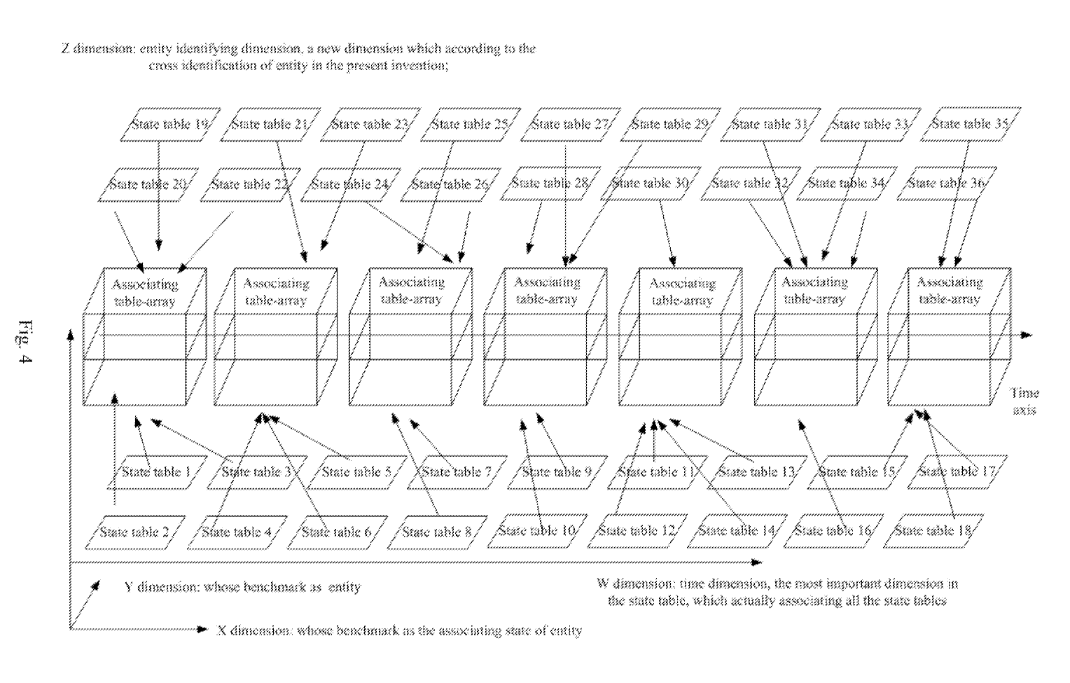

In the associating aspect between state tables, as shown in FIG. 4, the state table is similar to the entity table of present invention, which also can be associated the state tables through the cross identifying among entities and formed a associating table-array module. The cross identifying among entities will be achieved through the described program of former Table. 7-9 and FIG. 3. Since the associating module which storing the identification of entity associated to this entity in the other entities is already set in the entity table, the state table cannot store identification of the other entities associated to main entity for save more storage space, which can be changed to inquire the identification of associating entity and property in the entity table through identification of main entity. As optional program, it also can be found the identification of other entities associated to main entity in the associating state module of state table.

Furthermore, since the state has very large relationship with time, compared to the entity table, the additional important dimension of state table is time dimension, such as the time dimension module in Table. 10 and Table. 11. Thus, the associating among the state tables will have one more time dimension which is a four-dimensional associating.

Referring to FIG. 4, the stored information is formed through X dimension (whose benchmark as the associating state of entity) and Y dimension (whose benchmark as entity), such as state table 1-36. The state table-array module (each cubic as shown in figure) is constituted by these state tables through Z dimension (entity identifying dimension, which is the new dimension according to the cross identification of entity in the present invention), and these state tables are associating through the W dimension (time dimension, the most important dimension in the state table, which actually associating all the state tables). Finally, it achieves the four-dimensional associating technical proposal of the state table module.

4. Association Between the Entity Module and State Table Module

The entity table module is mainly for defining various properties of entity and associating identifying (includes the entity identifying and associating entity identifying), and the state module is mainly for defining the cross associating the other entities state of entity at different time. The associating entity stored in the associating module of entity table includes the associating entities which are happening activities (that is dynamic association) with the main entity in this entity table, and these activities are stored in the state table of this main entity. In addition, the identification of entity which has a static association with the main entity is stored in the associating module of entity table. For example, the static association includes the inclusion and included relation etc. The associating state module includes the activities which happened by the main entity and the other associating entity, and further includes the state of main entity in itself etc. Then entity table module can be associated to the state table module through the entity identifying module, thereby roundly reflecting the static and dynamic information of entity. After the association of entity table and state table, it can be chose a proper dimension as the benchmark according to the necessary for the optimized organizing and managing of data, and it is convenient for the operation of storing, inquiring and maintaining of data. For example, when multi-dimensional market information, the operation of storing, inquiring and maintaining the data through the base of time dimension, so it can process the multi-dimensional market information effectively.

5. Handling Process of Multi-Dimensional Information:

(1) Adding the Multi-Dimensional Information:

The data storage scheme of the present invention is structuring the data storage module which associated each other, mainly using the time dimension as benchmark, and utilizing data identifying technology through defining several different dimensions. Then, the storage model is formed according to the data storage module and stores the multi-dimensional information to the database.

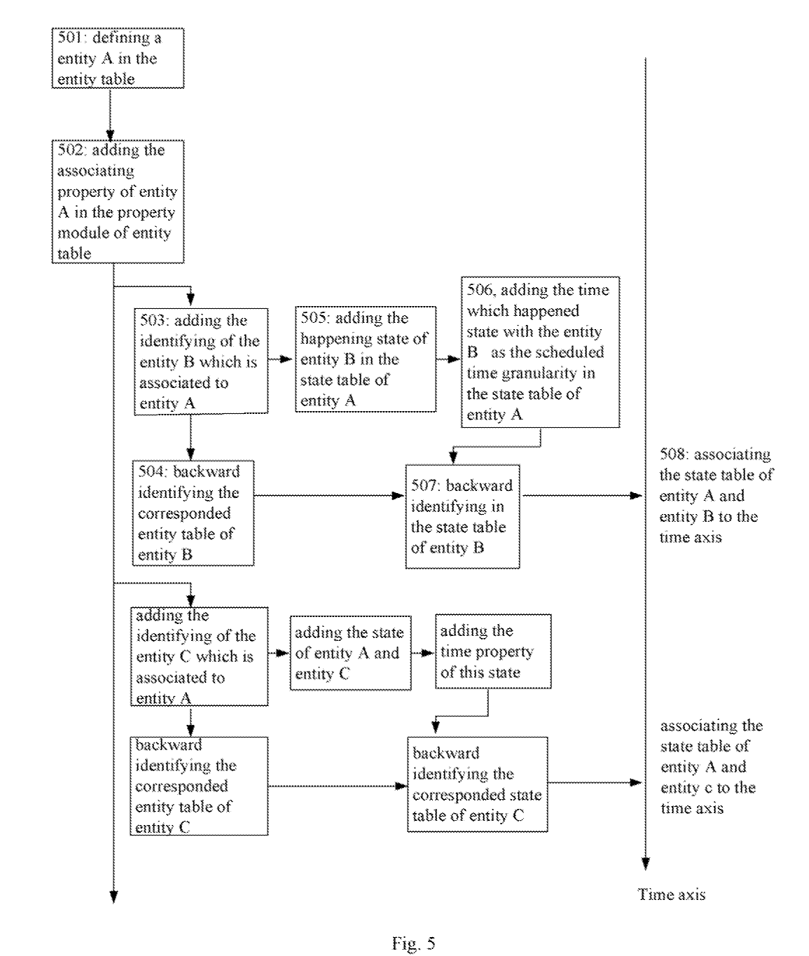

FIG. 5 is a process schematic drawing according to the embodiment of the present invention, which adding an entity, identifying the other associated entities and states and storing to the database. The specific storage process as following (as adding the entity A for example, the entity B and entity C are already the entities stored in the database):

Step 501, defining the entity A in the entity table;

Step 502, adding the associating property of entity A in the property module of entity table;

Step 503, adding the identification of the entity B which is associated to entity A;

Step 504, backward identifying the corresponded entity table of entity B, and establishing an entity table-array module (includes the entity table of entity A and the entity table of entity B), the backward identifying is automatic proceeded;

Step 505, adding the happening state of entity B in the state table of entity A;

Step 506, adding the time which is happened a state with the entity B as the scheduled time granularity in the state table of entity A;

Step 507, backward identifying in the state table of entity B (includes adding the state and happening time with entity A), and establishing a state table-array module (includes the table of entity A and the table of entity B), the backward identifying is automatic proceeded;

Step 508, associating the state table of entity A and entity B to the time axis according to the time property of the state table modules of entity A and entity B in the database system.

One approach of the specific implementation process of the identification and backward identification in the above steps is referred to FIG. 7.

The steps adding another associating entity C of entity A are repeated the step 503 to step 508. After the database system adding the entity table and state table which associated to the entity C to the established entity table-array module and state table-array module, the entity table-array module and state table-array module already includes the entity tables and state tables between two of entity A, entity B and entity C, in the state table-array module, the state tables of entity A, entity B and entity C are associated through the time axis.

With the increase of the date in database, the number of members in the entity table-array module and the state table-array module will continuously increasing.

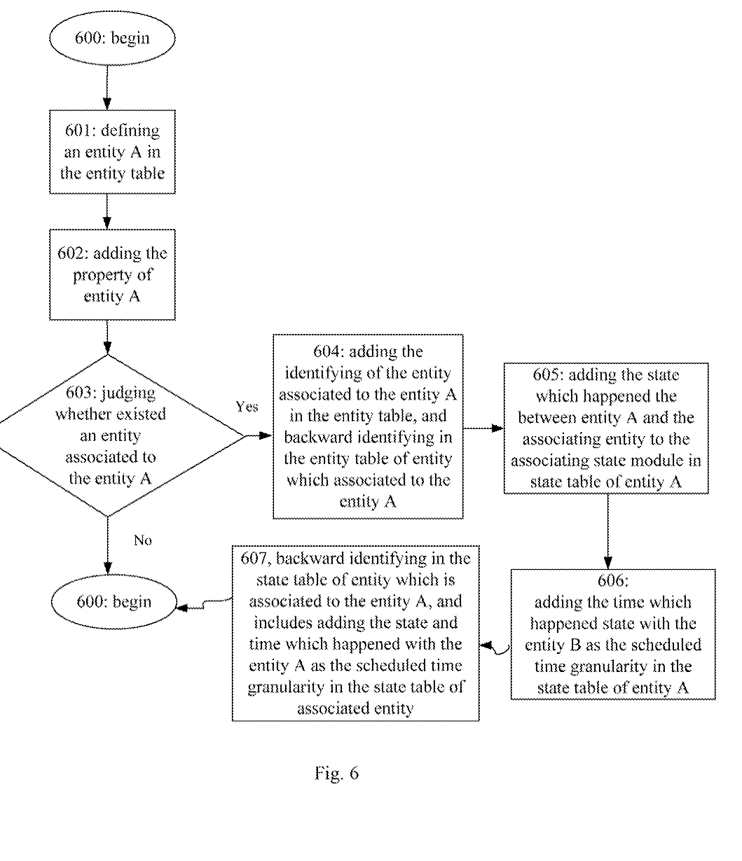

FIG. 6 is a flow chart according to an embodiment of the present invention, which adding an entity, identifying the other associated entities and states and storing to a database.

Step 600: a process is started;

Step 601: defining an entity A in the entity table;

Step 602: adding the property of entity A;

Step 603: judging whether existed an entity associated to the entity A, if yes, proceeding to step 604, if no, proceeding to step 608;

Step 604: adding the identification of the entity associated to the entity

A in the entity table, and backward identifying in the entity table of entity which associated to the entity A;

Step 605, adding the state which happened the between entity A and the associating entity to the associating state module in state table of entity A;

Step 606, adding the time which happened state with the entity B as the scheduled time granularity in the state table of entity A;

Step 607, backward identifying in the state table of entity which is associated to the entity A, and includes adding the state and time which happened with the entity A as the scheduled time granularity in the state table of associated entity;

Step 608, the processed is ended.

(2) Managing Multi-Dimensional Information

Since the source data identifying technology is automatically backward generated, compared to the traditional two-dimensional data technology, the management is very simple. When the system is amending one of identification in the entity module, the entity identifying in another table is also automatically changed as follow according to the generation of automatic backward identifying.

The specific implementation process of the identification and backward identification is referred to FIG. 7.

Firstly, the database will judge the user operating the entity table or state table (step 702), and it will be divided to the following two situations:

Manager operates amending the associating entity B (receptor B) in the table of entity A (main body A), and the system searches the entity list in the database and requests as the method of user select receptor to achieve this associated amending (step 703). After selecting, at the same time of amending the user's operation to database, system will additionally inquire the associating information in associating receptor of this step in the entity table and automatically add the receptor of this table to the entity table, and provide to the manager who will ensure this backward identifying work (step 705). If this step does not find the receptor existed in the database, it will request the user must add the corresponded information of this receptor to the entity table (step 704), which guarantee this backward identifying can be successful finished.

Since the state table itself is also associated to the entity table, adding or amending the receptor in the state table of main body A is similarly to the backward identifying steps of entity table, it is also required to identification and backward identification in the entity table. The difference is that the time of state table of receptor is associated automatically (step 708) in the backward identification of state table except identifying entity, because the state table has one more time dimension than the entity table. In addition, since the unpredictable state backward identifying, manager should ensure the happening state of the main body and receptor in step 707 and step 709.

Although FIG. 7 only provides an example to illustrate the identification and backward identification when adding and amending, the present invention is not limit on this. However, the people skilled in this art will understand the operation of deleting is also based on the above scheme to achieve the identification and backward identification.

In conclusion, the identifying step for the entity table includes: storing, amending or deleting the identification of associating entity which is associated to the entity of entity table in the associating entity module of entity table.

Steps of the backward identification for the entity table include: the steps of the backward identification: searching the entity table corresponded to the associating entity in database through the identification of the associating entity; if yes, then storing, amending or deleting the identification of entity in the associating entity module of entity table which is associated with the associating entity; if no, and the operation of storing or amending is processed in the associating entity module of entity table, so the entity table is created by the associating entity, and storing or amending the identification of entity in the associating entity module of the entity table which is created for the associating entity.

Steps of identification for the state table include: storing, amending or deleting the happening state of main entity and the associating entity in the associating state module of state table, and storing, amending or deleting the happening time of the state in the time dimension module of state table.

Steps of the backward identification for the state table include: searching the state table which is corresponded to the associating entity in database through the identification of the associating entity; if yes, storing, amending or deleting the happening state of main entity and the associating entity in the associating state module of state table which is corresponded to the associating state, and storing, amending or deleting the happening time of the state in the time dimension module of state table; if no, and the operation of storing or amending is processed in the associating state module of state table, so the state table is created by the associating entity, and storing or amending the identification of entity in the associating entity module of the state table which is created for the associating entity, and storing, amending or deleting the happening time of the state in the time dimension module of state table.

6. Database Inquiry Module

After setting the data storage structure, the present invention can completely classify and save the multi-dimensional information to the multi-dimensional database. In addition, the present invention also provides a situation which is modularity and generality cross inquiry various multi-dimensional information, and return to the two-dimensional table type inquiry results. Specifically, the present invention can process inquiry to the multi-dimensional information from multi-dimension through entity, state and time etc. and return a one-dimensional table type inquiry result.

As shown in FIG. 8, the specific inquiry steps as following (as inquiry of entity A for the example):

User presents an inquiry request, inquiring the activity occurred between 1 o'clock and 2 o'clock of entity A;

Step 801, inputting the inquiry request of user, and sending inquiry order in the database system; Step 802, judging whether the entity is recorded in the database, if no, returning and inquiring null value at step 803, if yes, inquiring the entity table which associating to the entity at step 804;

Step 805, judging whether the other entity tables associated to the entity are existed in the database; if no, returning to the inquiry result and appearing the property of entity in entity table at step 806; if yes, reading record in the entity table which associated to the entity, and saving the record in a buffer area of a server at step 807.

Step 808, intercepting a time point in the database, and judging whether the state table associated to the entity is existed at the intercepted time point; if yes, proceeding to step 809, if no, proceeding to step 810;

Step 809, reading the associated record in the state table which is associated to this entity;

Step 810, judging whether the other state tables associated to the entity are existed in the database; if no, reading the buffer area of the server and returning to the inquiry result at step 812, if yes, reading the record in the associated other state tables, which is associated to the entity, and saving the record to the buffer area of the server at step 811;

Step 812, reading the buffer area of the server and returning to the searching result.

Referring to Table. 12, this table is an example of present invention in practical application, wherein the column F1 is the inquiry result in the entity table-array module, column F2 is the inquiry result from the state table-array of entity A, column F3 is the result of intercepted time axis, and column F4 is the result which is presented by the source data cross identifying technology.

TABLE 12
Inquiry results of multi-dimensional database inquiry module

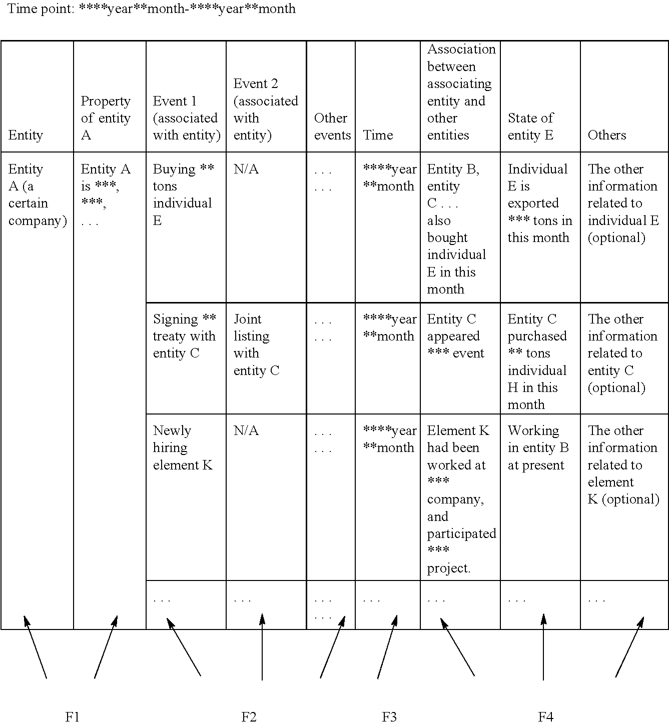

FIG. 9 is a schematic drawing of data storage method according to an embodiment of the present invention; the method includes the following steps: Step 900, begin; Step 901, establishing an entity table for storing entity information in a database; Step 902, storing the entity information into the entity table; Step 903, establishing a state table for storing state information of the entity in the database; Step 904, storing the state information of the entity into the state table; Step 905, associating the entity table with the state table; Step 906, associating the state tables by using time dimension; Step 907, end.

Step 901 further includes: setting an entity identifying module, a entity associating module and a property module in the entity table, the entity identifying module is configured to store the identification of entities, the entity associating module is configured to store the identification of entity which associating to the corresponded entity in the other entity tables, and the property module is used for storing property which associating to the corresponded entity; associating multiple entity tables by the use of the associating entity module, so as to form a three-dimensional entity table-array module; Step 903 further includes: Setting a time dimension module, a main entity indentifying module and a associating state module in the state table, the time dimension module is used for storing the state happening time of the main entity as scheduled time granularity, the main entity identifying module is used for storing the identification of main entity, the associating state module is used for storing the associating state of the main entity; Multiple state tables are associated by the use of associating entity module in the entity table of main entity or the associating state module in the state table, which will be formed a three-dimensional state table-array module. Thereof, step 905 further includes: Entity table is associated to the state table through the entity identifying module in the entity table and the main entity identifying module in the state table; and wherein the data is multi-dimensional market data. Step 906 further includes: A four-dimensional state table associating module is formed by the three-dimensional table array module which is associated via the time dimension.

The associating entity module is set in the entity table through identification and backward identification. Wherein steps of identification include: Storing, amending or deleting the identification of associating entity which is associated to the entity in entity table; Steps of the backward identification include: searching the entity table corresponded to the associating entity in database through the identification of the associating entity; if yes, then storing, amending or deleting the identification of entity in the associating entity module of entity table which is associated to the associating entity; if no, and the operation of storing or amending is processed in the associating entity module of entity table, so the entity table is created by the associating entity, and storing or amending the identification of entity in the associating entity module of the entity table which is created for the associating entity.

The associating state module is set in the state table through identification and backward identification. Wherein the steps of identification include: storing, amending or deleting the happening state of main entity and the associating entity in the associating state module of state table, and storing, amending or deleting the happening time of the state in the time dimension module of state table; Steps of the backward identification include: searching the state table which is corresponded to the associating entity in database through the identification of the associating entity; if yes, storing, amending or deleting the happening state of main entity and the associating entity in the associating state module of state table which is corresponded to the associating state, and storing, amending or deleting the happening time of the state in the time dimension module of state table; if no, and the operation of storing or amending is processed in the associating state module of state table, so the state table is created by the associating entity, and storing or amending the identification of entity in the associating entity module of the state table which is created for the associating entity, and storing, amending or deleting the happening time of the state in the time dimension module of state table.

The above steps of backward identifying can automatically proceed.

The present invention further provides a data storage structure, including: an entity table which is established in database, and used for storing entity information; a state table which is established in database, and used for storing state information of entity; the entity table is associated to the state table; wherein, the state table is associated through time dimension. the entity table further includes: an entity identifying module, a associating entity module and a property module, the entity identifying module is used for storing the identification of entity, the associating entity module is used for storing the identification of entity in the other entity table, which is associated to the entity, and the property module is used for storing the property of corresponded entity; Multiple entity tables are associated by the use of the associating entity module, which will be formed a three-dimensional entity table-array module; Thereof, the state table further includes: a time dimension module, a main entity identifying module and a associating state module, the time dimension module is used for storing the state happening time of the main entity as scheduled time granularity, the main entity identifying module is used for storing the identification of main entity, the associating state module is used for storing the associating state of the main entity; A three-dimensional state table-array module will be formed by the use of associating entity module in the entity table of main entity or the associating state module in the state table, and a four-dimensional state table associating module is formed by the three-dimensional table-array module which is associated via the time dimension. Wherein, the entity table is associated to the state table through the entity identifying module in the entity table and the main entity identifying module in the state table.

The present invention further provides a data storage method in the date storage structure according to the above data storage structure, including the following steps: defining the entity in the entity table; adding the property of entity; judging whether the entity associating to said entity is existed; if yes, adding a identification of associating entity which is associated to the entity in the entity table, and processing a backward identification in the entity table of the associating entity; adding a happening state of the entity and the associating entity in the associating state module of the entity state table; Adding the happening time of the entity and associating entity as scheduled time granularity in the state table of entity; Processing the backward identification in the state table of associating entity, and adding the happening time of the entity and associating entity as scheduled time granularity in the state table of associating entity.

The present invention further provides a method of inquiring storage date according to the data storage method of present invention, including the following steps: Input an inquiry request of user and sending a inquiry order in a database system; Judging whether the entity is recorded in the database; If no, returning and inquiring null value; If yes, inquiring the entity table which associating to the entity; Judging whether the other entity tables associated to the entity are existed in the database; If no, returning to the inquiry result and appearing the property of entity in entity table; If yes, reading record in the entity table which associated to the entity, and saving the record in a buffer area of a server, Intercepting a time point in the database, and judging whether the state table associated to the entity is existed at the intercepted time point; If yes, reading associated record in the other associating state table, which is associated to the entity, if no, reading the buffer area of the server and returning to the inquiry result, if yes, reading the record in the other associating state tables, which is associated to the entity, and saving the record to the buffer area of the server; Reading the buffer area of the server and returning to the searching result.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A data storage method, comprising the steps of:
a) establishing an entity table for storing entity information in a database;
b) storing the entity information into the entity table;
c) establishing a state table for storing state information of entities in the database;
d) storing the state information of the entity into the state table;
e) associating the entity table to the state table;
f) associating the state tables to each other via time dimension.

2. A data storage method according to claim 1, wherein step a) further comprises:
setting an entity identifying module, an entity associating module and a property module in the entity table, the entity identifying module is configured to store the identification of entities, the entity associating module is configured to store the identification of entity which associating to the corresponded entity in the other entity tables, and the property module is used for storing property which associating to the corresponded entity;
associating multiple entity tables by the use of the associating entity module, so as to form a three-dimensional entity table-array module;
wherein step c) further comprises:
setting a time dimension module, a main entity indentifying module and a associating state module in the state table, the time dimension module is used for storing the state happening time of the main entity as scheduled time granularity, the main entity identifying module is used for storing the identification of main entity, the associating state module is used for storing the associating state of the main entity;
associating multiple state tables by the use of associating entity module in the entity table of main entity or the associating state module in the state table so as to form a three-dimensional state table-array module;
step c) further comprises:
associating entity table to the state table through the entity identifying module in the entity table and the main entity identifying module in the state table; and
wherein the said data is multi-dimensional market data.

3. A data storage method according to claim 1, wherein step f) further comprises:
associating the three-dimensional table array module via the time dimension to form four-dimensional state table associating module.

4. A data storage method according to claim 2, wherein the associating entity module is provided in the entity table through identification and backward identification.

5. A data storage method according to claim 4, wherein the step of identification comprised: storing, amending or deleting the identification of associating entity which is associated to the entity in entity table;
the step of the backward identification comprise: searching the entity table corresponded to the associating entity in database through the identification of the associating entity; if yes, then storing, amending or deleting the identification of entity in the associating entity module of entity table which is associated to the associating entity; if no, and the operation of storing or amending is processed in the associating entity module of entity table, so the entity table is created by the associating entity, and storing or amending the identification of entity in the associating entity module of the entity table which is created for the associating entity.

6. A data storage method according to claim 2, wherein the associating state module is provided in the state table through identification and backward identification.

7. A data storage method according to claim 6, wherein the steps of identification comprise: storing, amending or deleting the happening state of main entity and the associating entity in the associating state module of state table, and storing, amending or deleting the happening time of the state in the time dimension module of state table;
steps of the backward identification comprise: searching the state table which is corresponded to the associating entity in database through the identification of the associating entity; if yes, storing, amending or deleting the happening state of main entity and the associating entity in the associating state module of state table which is corresponded to the associating state, and storing, amending or deleting the happening time of the state in the time dimension module of state table; if no, and the operation of storing or amending is processed in the associating state module of state table, so the state table is created by the associating entity, and storing or amending the identification of entity in the associating entity module of the state table which is created for the associating entity, and storing, amending or deleting the happening time of the state in the time dimension module of state table.

8. A data storage method according to claim 5 or 7, wherein the steps of backward identification is an automatically process.

9. A data storage structure, comprising:
an entity table which is established in database, and used for storing entity information;
a state table which is established in database, and used for storing state information of entity;
the entity table is associated to the state table;
wherein the state table is associated through time dimension.

10. A data storage structure according to claim 9, wherein the entity table further comprises: an entity identifying module, a associating entity module and a property module, the entity identifying module is used for storing the identification of entity, the associating entity module is used for storing the identification of entity in the other entity table, which is associated to the entity, and the property module is used for storing the property of corresponded entity;
multiple entity tables are associated by the use of the associating entity module, which will be formed a three-dimensional entity table-array module; Wherein, the state table further comprises: a time dimension module, a main entity identifying module and a associating state module, the time dimension module is used for storing the state happening time of the main entity as scheduled time granularity, the main entity identifying module is used for storing the identification of main entity, the associating state module is used for storing the associating state of the main entity;
a three-dimensional state table-array module will be formed by the use of associating entity module in the entity table of main entity or the associating state module in the state table, and a four-dimensional state table associating module is formed by the three-dimensional table-array module which is associated via the time dimension.
wherein the entity table is associated to the state table through the entity identifying module in the entity table and the main entity identifying module in the state table.

11. A data storage method in the date storage structure according to claims 9 to 10, comprising the following steps:
defining the entity in the entity table;
adding the property of entity;
judging whether the entity associating to said entity is existed;
if yes, adding a identification of associating entity which is associated to the entity in the entity table, and processing a backward identification in the entity table of the associating entity;
adding a happening state of the entity and the associating entity in the associating state module of the entity state table;
adding the happening time of the entity and associating entity as scheduled time granularity in the state table of entity;
processing the backward identification in the state table of associating entity, and adding the happening time of the entity and associating entity as scheduled time granularity in the state table of associating entity.

12. A method of inquiring storage date according to claims 1 to 8, comprising the following steps:
inputting an inquiry request of user and sending a inquiry order in a database system;
judging whether the entity is recorded in the database;
if no, returning and inquiring null value;
if yes, inquiring the entity table which associating to the entity;
judging whether the other entity tables associated to the entity are existed in the database;
if no, returning to the inquiry result and appearing the property of entity in entity table;
if yes, reading record in the entity table which associated to the entity, and saving the record in a buffer area of a server;
intercepting a time point in the database, and judging whether the state table associated to the entity is existed at the intercepted time point;
if yes, reading associated record in the other associating state table, which is associated to the entity, if no, reading the buffer area of the server and returning to the inquiry result, if yes, reading the record in the other associating state tables, which is associated to the entity, and saving the record to the buffer area of the server;
reading the buffer area of the server and returning to the searching result.
